(19) United States
(12) Patent Application Publication
(10) Pub. No.: US 2017/0242851 A1
(43) Pub. Date: Aug. 24, 2017

(54) NON-TRANSITORY COMPUTER READABLE MEDIUM, INFORMATION SEARCH APPARATUS, AND INFORMATION SEARCH METHOD

(71) Applicant: FUJI XEROX CO., LTD., Tokyo (JP)

(72) Inventors: Seiji SUZUKI, Kanagawa (JP); Motoyuki TAKAAI, Kanagawa (JP); Nami TOKUNAGA, Kanagawa (JP)

(73) Assignee: FUJI XEROX CO., LTD., Tokyo (JP)

(21) Appl. No.: 15/218,408

(22) Filed: Jul. 25, 2016

(30) Foreign Application Priority Data
Feb. 19, 2016 (JP) 2016-029515

(51) Int. Cl. G06F 17/30

(52) U.S. Cl. CPC G06F 17/30011; G06F 17/30867; G06F 17/30598; G06F 17/30554

(57) ABSTRACT

A non-transitory computer readable medium storing a program causing a computer to execute a process for information search, includes searching a document database for a basic document which is a document containing an input keyword; searching the document database for an associated document associated with the basic document; generating plural document sets by classifying a document group containing plural associated documents; and outputting, for each document set, a feature word which is a word characteristic to the document set.

### CROSS-REFERENCE TO RELATED APPLICATIONS

This application is based on and claims priority under 35 USC 119 from Japanese Patent Application No. 2016-029515 filed Feb. 19, 2016.

### BACKGROUND

### Technical Field

The present invention relates to a non-transitory computer readable medium, an information search apparatus, and an information search method.

Hitherto, information search apparatuses which search a document database for a document containing an input keyword input by a user and displays a list of documents as a search result have been known.

### SUMMARY

According to an aspect of the invention, there is provided a non-transitory computer readable medium storing a program causing a computer to execute a process for information search, including searching a document database for a basic document which is a document containing an input keyword; searching the document database for an associated document associated with the basic document; generating plural document sets by classifying a document group containing plural associated documents; and outputting, for each document set, a feature word which is a word characteristic to the document set.

### BRIEF DESCRIPTION OF THE DRAWINGS

Exemplary embodiments of the present invention will be described in detail based on the following figures, wherein:

FIG. 1 is a block diagram illustrating an example of a configuration of an information search apparatus;

FIG. 2 is a flowchart illustrating an example of the flow of an information search process performed by the information search apparatus;

FIG. 3 is a flowchart illustrating an example of the flow of a document set generation process of the information search process performed by the information search apparatus;

FIG. 4 is a flowchart illustrating an example of the flow of a feature word output process of the information search process performed by the information search apparatus;

FIG. 5 is a diagram illustrating an example of a conceptual hierarchy dictionary; and

FIG. 6 is a diagram illustrating a display example of a search result.

### DETAILED DESCRIPTION

Hereinafter, exemplary embodiments of the present invention will be described below with reference to drawings.

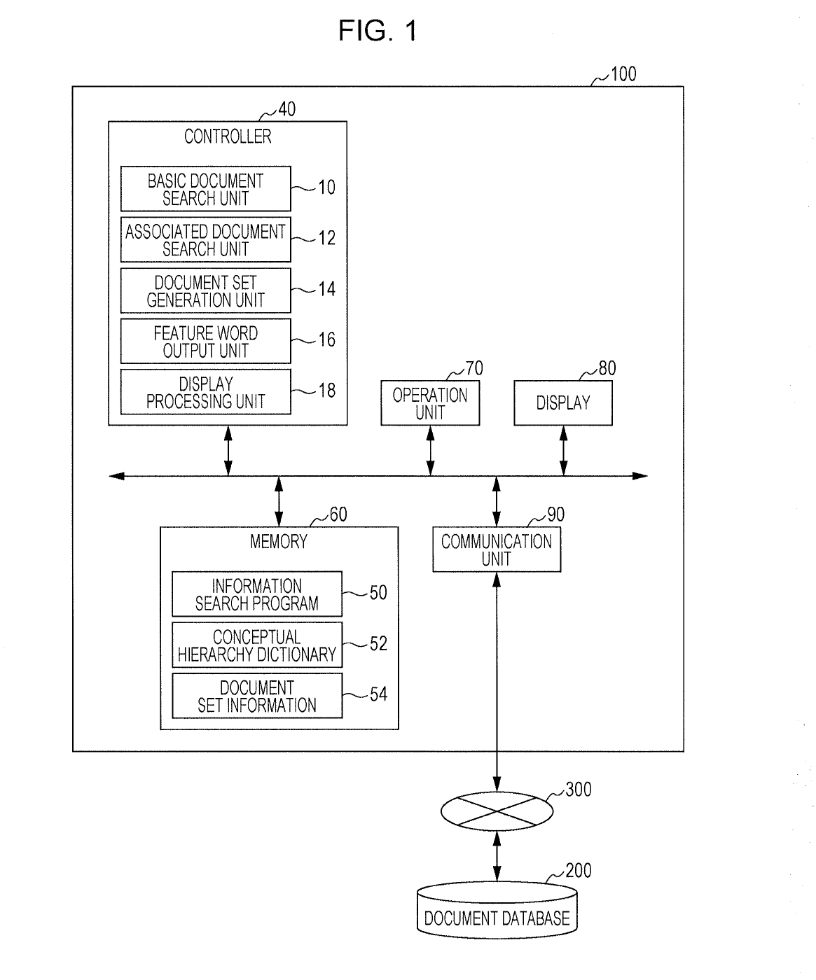

FIG. 1 is a block diagram illustrating an example of a configuration of an information search apparatus 100 according to an exemplary embodiment. The information search apparatus 100 includes a controller 40, a memory 60, an operation unit 70, a display 80, and a communication unit 90.

The controller 40 is a processor such as a central processing unit (CPU), and performs information processing in accordance with an information search program 50 stored in the memory 60. The memory 60 includes a read only memory (ROM), a random access memory (RAM), a hard disk, and the like. The memory 60 stores the information search program 50 to be executed by the controller 40, temporary data, and the like, and stores a conceptual hierarchy dictionary 52 and document set information 54, which will be described later. The communication unit 90 is, for example, a network card, and communicates with a document database 200 and the like via a network 300 such as a local area network (LAN), the Internet, and the like. The document database 200 may be stored in the memory 60. The operation unit 70 includes a keyboard, a mouse, a touch panel, and the like, and receives a search instruction and the like from a user. The display 80 is a display. The display 80 displays a screen for urging a user to issue a search instruction, displays a search result, and the like.

When performing information processing in accordance with the information search program 50 stored in the memory 60, the controller 40 functions as a basic document search unit 10, an associated document search unit 12, a document set generation unit 14, a feature word output unit 16, a display processing unit 18, and the like. The information search program 50 may be provided through communication via the Internet or the like or may be stored in a computer readable recording medium such as an optical disc and provided.

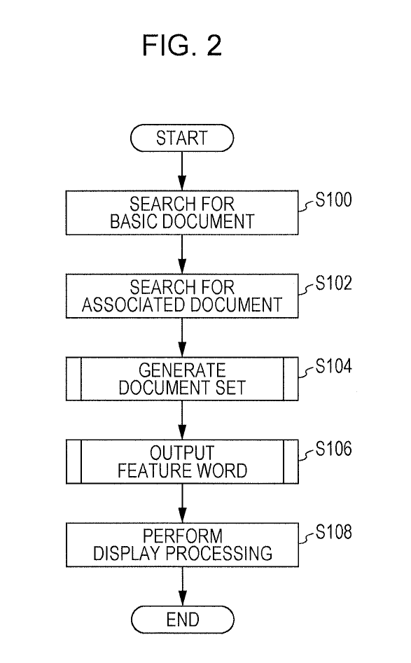

FIG. 2 is a flowchart illustrating an example of the flow of an information search process performed by the information search apparatus 100. The information search process performed by the information search apparatus 100 will be described below with reference to FIG. 2.

First, in S100, the basic document search unit 10 receives a keyword input by a user via the operation unit 70. Hereinafter, a keyword will be called an input keyword. A “keyword” is not limited to a word. A “keyword” may be a phrase or a clause. The basic document search unit 10 searches the document database 200 for a basic document which is a document containing the received input keyword. Then, the basic document search unit 10 outputs information of the basic document found in the search to the associated document search unit 12 and the document set generation unit 14. Information of the basic document may be information containing the entire contents of the basic document or may be minimum information which may identify the basic document, such as the name of a document or the like.

In S102, the associated document search unit 12 receives the information of the basic document, and searches the document database 200 for an associated document which is a document associated with the basic document. Various methods are available as a method for searching for an associated document. In an exemplary embodiment of the present invention, the method for searching for an associated document is not limited to a specific method. For example, the methods described below are available.

### (1) Method Based on Term Vector

In this method, a word contained in a document is extracted, a multi-dimensional vector (term vector) containing a value representing the appearance frequency of the word as a component is configured, a cosine value of the angle formed by a multi-dimensional vector of a specific document and a multi-dimensional vector of a different document, that is, the inner product of two multi-dimensional vectors, is calculated, and in the case where the value of the calculation result is equal to or more than a threshold, it is determined that the specific document is similar to the different document. With this method, a document with a similar word appearance frequency may be found as an associated document.

### (2) Method Using Deep Layer Learning (Convolutional Neural Network)

In this method, deep layer learning using a neural network is performed in advance using a sufficient amount of images. Therefore, in the case where an image such as a screen shot or a thumbnail of a document is input to the neural network, features of the image appears on output of a cell group including a layer of a certain depth of the neural network or a specific cell group selected artificially. By defining output of the cell group as a vector, the vector represents features of the image. With this method, on a neural network, the inner product of a vector obtained by inputting an image of a specific document and a vector obtained by inputting an image of a different document is calculated, and in the case where the value of the calculation result is equal to or more than a threshold, it is determined that the specific document is similar to the different document. With this method, for example, it may be determined that a document of a Japanese version and a document of an English version, which have the same layout for explanatory diagrams and sentences, are similar to each other.

### (3) Method Using Information of Community

There is a known technique in which based on records of access to a document, for example, users who have accessed the same document a predetermined number of times or more are categorized into the same group as associated users (a community is extracted). Even in the case where a community is not extracted using the above access records, for example, if association information indicating that a section or a team in a company and information of an employee belonging to the section or the team are associated with each other exists, a community may already be extracted. For example, the method described below is available as a method for finding an associated document using information of such a community. It may be estimated that documents accessed by users who belong to the same community are potentially associated with each other from the background such as business, interests, and the like. Thus, it is determined, by checking access records of individual documents, that documents accessed by many of users belonging to the same community are associated with each other. With this method, even if the contents of documents are completely different from each other, the documents may be determined to be associated with each other.

Basically, the associated document search unit 12 adopts, as a method for searching for an associated document, a method in which a document containing a similar word is searched for as an associated document, like the method (1) using a term vector. However, as in the method (2) using deep layer learning or the method (3) using information of a community, a method in which a document containing a completely different word may be searched for as an associated document, may be adopted. The associated document search unit 12 outputs information of the associated document found in the search to the document set generation unit 14. Information of an associated document may include the entire contents of the associated document or may include only minimum information that may identify the associated document, such as the name of the document.

Next, in S104, the document set generation unit 14 receives the information of the basic document and the information of the associated document, and generates plural document sets by classifying document groups including basic documents and associated documents.

Methods for generating document sets by the document set generation unit 14 include two generation methods according to the method for searching for an associated document by the associated document search unit 12. The first generation method is a method for generating a document set for the case where the associated document search unit 12 searches for an associated document for each basic document. The second generation method is a method for generating a document set for the case where the associated document search unit 12 searches for an associated document for a collection of plural basic documents.

First, the first generation method will be described. In the case where the associated document search unit 12 searches for an associated document for each basic document, the document set generation unit 14 generates a document set including the basic document and an associated document, which is a document associated with the basic document obtained as a search result. That is, a document set is generated for each basic document. However, in the case where an associated document which is found in the search as a document associated with a basic document is the same as a different basic document, a document set may not be generated for the different basic document. This is to avoid a situation in which in the case where the basic document search unit 10 searches for a basic document containing an input keyword, a large number of basic documents of different versions having little difference in the contents thereof are often found in the search, and if a document set is generated for the individual basic documents, a large number of document sets with little difference among them is generated.

Next, the second generation method will be described. In the case where the associated document search unit 12 searches for an associated document from a collection of plural basic documents, the document set generation unit 14 classifies document groups using one or more of known various clustering approaches, and generates plural document sets. The case where an associated document is search for from the collection of plural basic documents may be, for example, a case where, based on the term vector method (1) described above, multi-dimensional vectors for individual basic documents are obtained, the average of the multi-dimensional vectors are obtained by adding the obtained multi-dimensional vectors together and dividing the result by the number of basic documents, and an associated document is searched for using the average multi-dimensional vector.

Furthermore, the document set generation unit 14 may perform a set operation with a previously generated document set to generate a document set. A previously generated document set is a document set generated by the previous information search process in the case where the current information search process (the series of processing operations illustrated in FIG. 2, the same applies to the below) is a re-search process using a feature word, which will be described below, output by the previous information search process or the like as an input keyword.

However, the present invention is not limited to the above. For example, in the case where the associated document search unit 12 searches for an associated document for each basic document and the document set generation unit 14 generates a document set including the basic document and the associated document associated with the basic document, when a document set for a basic document is generated and then a document set for a different basic document is generated, the already generated document set may be defined as a previously generated basic document.

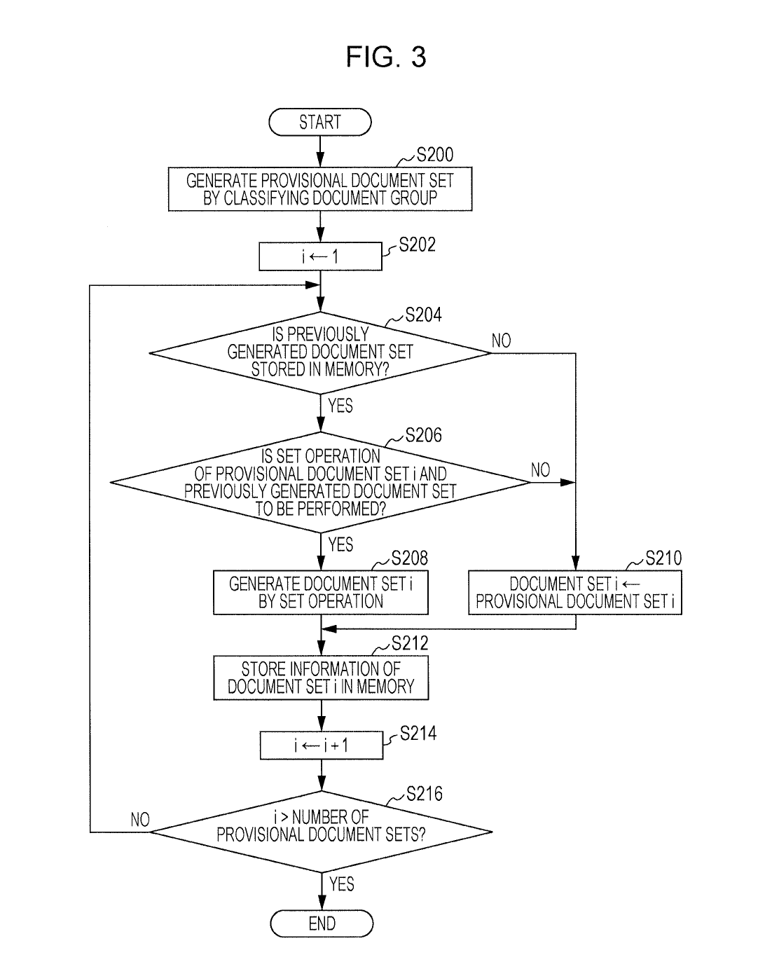

An example of a process for performing a set operation with a previously generated document set to generate a document set will be described below with reference to FIG. 3. First, in S200, provisional document sets are generated by classifying a document group including a basic document and an associated document.

In S202 and later processing, processing is performed for each of the generated provisional document sets. In S202, in order to process a provisional document set 1, which is the first provisional document set, a variable 1 is input. In S204, it is confirmed whether or not a previously generated document set is stored in the memory 60. Specifically, it is confirmed whether or not the document set information 54, which is information of a previously generated document set, is stored in the memory 60. The document set information 54 contains at least information identifying a document contained in a document set. In the case where a previously generated document set is not stored in the memory 60, a set operation is not possible, and therefore, the process proceeds to S210. In S210, processing for defining the provisional document set i as a document set i is performed. Specifically, the current value of i is 1, and therefore, processing for defining the provisional document set 1 as the document set 1 is performed.

In the case where a previously generated document set is stored in the memory 60 (S204: Yes), the process proceeds to S206. In S206, it is determined whether or not to perform a set operation of the provisional document set and the previously generated document set. This determination is implemented, for example, when a screen for urging a user to issue an instruction is displayed on the display 80 and the user issues an instruction using the operation unit 70. However, a determination as to whether or not to perform a set operation may be made in advance. In the case where a set operation is not to be performed (S206: No), the process proceeds to S210. In S210, processing for defining the provisional document set i as the document set i is performed.

In the case where a set operation is to be performed (S206: Yes), the process proceeds to S208. In S208, a set operation is performed, and processing for generating a document set i is performed. As a set operation, basically, an AND-NOT set operation is performed. An AND-NOT set operation represents a set operation in which a document not contained in a previously generated document set is extracted from among documents contained in the provisional document set i and a document set i including the extracted document is generated. In the case where there are plural previously generated document sets, a document not contained in any of the plural previously generated document sets is extracted from the documents contained in the provisional document set i, and a document set i including the extracted document is generated. However, for example, the user may identify, using the operation unit 70, a document set with which an AND-NOT set operation is to be performed, so that an AND-NOT set operation is performed only with the specific document set.

After the set operation is performed and the document set i is generated in S208, information of the generated document set i is stored as the document set information 54 in the memory 60 in S212. The current value of i is 1, and therefore, after the set operation is performed and the document set 1 is generated, information of the generated document set 1 is stored as the document set information 54 in the memory 60. Next, the process proceeds to S214. In S214, the variable i is incremented by one to perform processing for the next provisional document set. Then, in S216, it is confirmed whether or not the variable i is larger than the number of provisional document sets generated in S200, that is, document sets have been generated for all the provisional document sets. In the case where document sets have not been generated for all the provisional document sets (S216: No), the process returns to S204, and processing for generating a document set is performed for the next provisional document set 2. In the case where document sets have been generated for all the provisional document sets (S216: Yes), the process illustrated in the flowchart of FIG. 3 ends. In the case where no document exists within the document set, based on a result of the set operation in S208, generation for the document set may not be performed.

As described above, by performing an AND-NOT set operation, a document set including a document not contained in the previously generated document set may be generated. For the document set generated as described above, it is highly likely that a feature word different from a feature word of the previously generated document set is output. Therefore, compared to the case where a document set is generated without performing an AND-NOT set operation, more various feature words may be output.

A set operation is not limited to an AND-NOT set operation. An AND set operation or an OR set operation may be performed. In the case where an AND set operation is performed, a document contained in a previously generated document set is extracted from among documents contained in a provisional document set, and a document set including the extracted document is generated. Furthermore, in the case where an OR set operation is performed, a document set including a document contained in a provisional document set and a document contained in a previously generated document set is generated. As described above, by performing an AND set operation, an OR set operation, or the like, various document sets may be generated, and generation of document sets may become more flexible.

Referring back to FIG. 2, after the document set is generated in S104, the process proceeds to S106. In S106, the feature word output unit 16 performs, for each document set, feature word output processing for outputting a feature word, which is a word characteristic to the document set. Similar to a “keyword”, a “feature word” is not limited to a word. A “feature word” may be a phrase, a clause, or the like. Information of the document set generated at the document set generation unit 14 is input to the feature word output unit 16. Information of a document set includes at least information identifying a document contained in each document set.

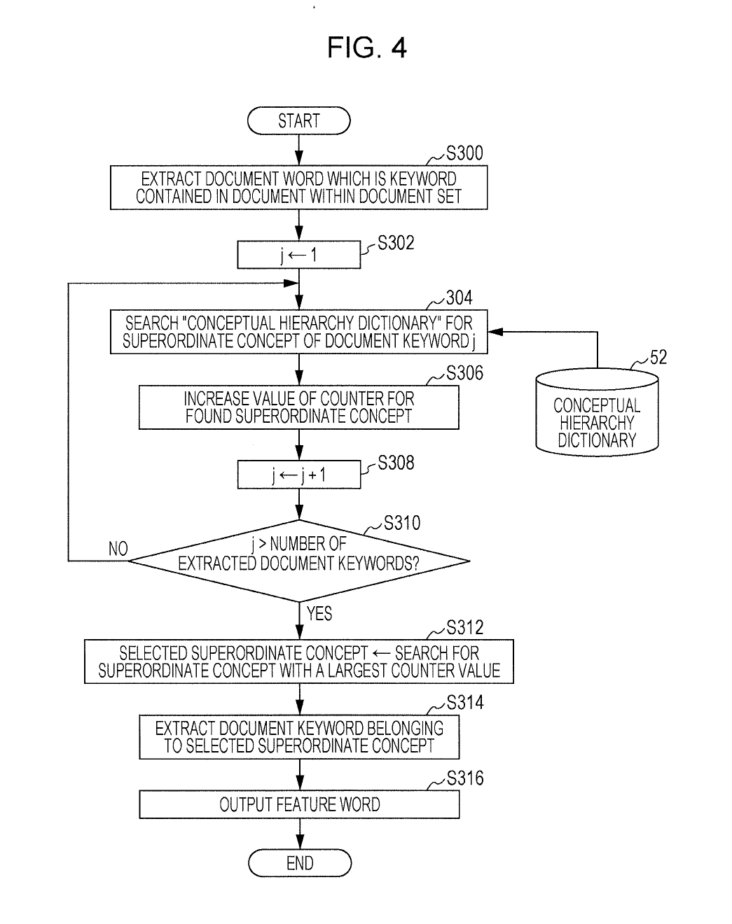

FIG. 4 is a flowchart illustrating an example of the flow of a process for outputting a feature word of a single document set. First, in S300, a document keyword, which is a keyword contained in a document within a document set, is output. At this time, a word such as a number and a day, which is generally used for a document, a company name which appears at the footer of each page of the document, and the like are not suitable as feature words. Therefore, it is desirable that the above words are not extracted as document keywords. In actuality, a large number of document keywords are extracted. However, for the sake of explanation, an example in which seven document keywords “iron”, “nickel”, “aluminum”, “brass”, “paper”, “glass”, and “dog” are extracted (hereinafter, referred to as an “example of seven document keywords”) will be described.

In processing of S302 to S310, processing is performed for each of the extracted document keywords. In S302, in order to process the first document keyword, 1 is input to a variable j. In S304, a superordinate concept of the document keyword j is searched for in the conceptual hierarchy dictionary 52. The current value of j is 1, and therefore, a superordinate concept of the document keyword 1 “iron”, which is the first document keyword, is searched for.

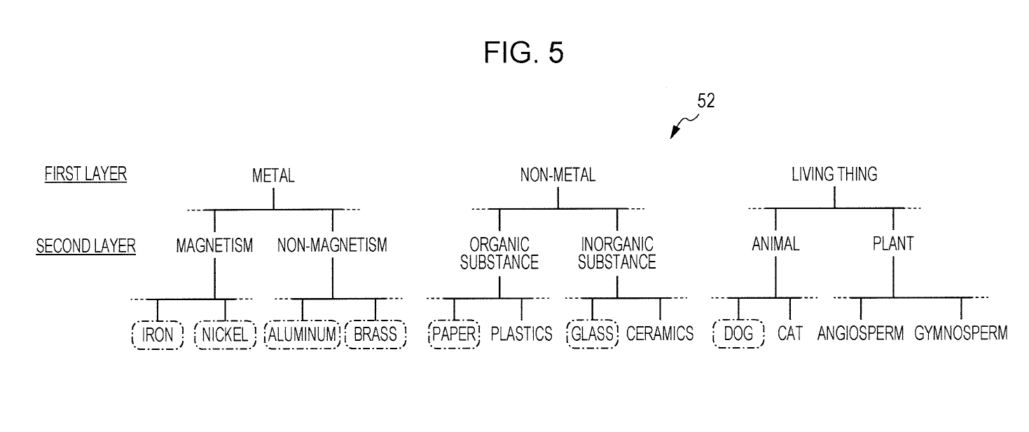

FIG. 5 is a diagram illustrating an example of a conceptual hierarchy dictionary. The seven document keywords extracted in S300 of FIG. 4 are surrounded by a single-dot broken line. A conceptual hierarchy dictionary represents the relationship between superordinate and subordinate concepts of a word. As illustrated in FIG. 5, a superordinate concept of the document keyword 1 “iron” is “magnetism” which is in the second layer and “metal” which is in the first layer. The superordinate concept to be searched for may be a word in the second layer or a word in the first layer. In this example, however, a layer to be searched for is determined in advance, and with respect to all the document keywords, superordinate concepts in the same layer are searched for. In this exemplary embodiment, a word in the first layer is searched for. Thus, in S304, “metal” is found in the search as a superordinate concept of the document keyword 1 “iron”. In the case where the document keyword is a word in the first layer, which is the highest layer of the conceptual hierarchy dictionary 52 (for example, in the case of “metal” in FIG. 5), the word itself may be searched for.

Then, the process proceeds to S306. In S306, the value of a counter for the found superordinate concept is increased. For example, a counter whose initial value is set to 0 for each of “metal”, “non-metal”, and “living thing”, which are words in the first layer in FIG. 5, is prepared in advance, and in S306, processing for incrementing the counter for the found superordinate concept by one is performed. For the document keyword 1 “iron”, “metal” is found in the search. Therefore, the counter for “metal” is incremented by one, that is, the value is changed from 0 to 1.

In S308, in order to perform processing for the next document keyword, the variable j is incremented by one. Then, the process proceeds to S310. In S310, it is confirmed whether or not the variable j is larger than the number of document keywords extracted in S300, that is, processing for all the extracted document keywords is completed. In this case, there is a document keyword which has not been processed (S310: No). Therefore, the process returns to S304, and a superordinate concept of the next document keyword 1 “nickel” is searched for. As described above, search for a superordinate concept for all the document keywords (S304) and processing for increasing the value of the counter for the found superordinate concept (S306) are performed. When the processing for all the document keywords is completed, the determination result in S310 becomes affirmative, and the process proceeds to S312.

In S312, a selected superordinate concept which is the superordinate concept with the largest counter value is searched for. For “iron”, “nickel”, “aluminum”, “brass”, “paper”, “glass”, and “dog” in the example of the seven document keywords, superordinate concepts “metal”, “metal”, “metal”, “metal”, “non-metal”, “non-metal”, and “living thing” are found in order, based on the conceptual hierarchy dictionary of FIG. 5. Therefore, the value of the counter for “metal” becomes 4, the value of the counter for the “non-metal” becomes 2, and the value of the counter for the “living thing” becomes 1. Thus, in S312, “metal”, which is the superordinate concept with the largest counter value, is found in the search as a selected superordinate concept.

In S314, a document keyword belonging to the selected superordinate concept is extracted. In the example of the seven document keywords, “iron”, “nickel”, “aluminum”, and “brass”, which are document keywords belonging to the selected superordinate concept “metal”, are extracted. In S316, based on the extracted document keywords as feature words, output of feature words is performed. In this exemplary embodiment, only the superordinate concept with the largest counter value is defined as a selected superordinate concept. However, plural selected superordinate concepts may be searched for. For example, a superordinate concept with the second largest counter value may also be searched for as a selected superordinate concept. In this case, a document keyword belonging to each of the selected superordinate concepts is extracted, and the extracted document keyword is output as a feature word.

As described above, the feature word output unit 16 extracts a document keyword, which is a keyword contained in a document within a document set, searches for a selected superordinate concept, which is a superordinate concept whose number of document keywords having a common superordinate concept is larger than the other superordinate concepts, and outputs a document keyword having the found selected superordinate concept as a feature word.

In this exemplary embodiment, an associated document which is associated with a basic document, as well as the basic document containing an input keyword, is contained in a document set. Therefore, compared to the case where only a basic document is contained in a document set, various document keywords, which are keywords contained in the documents within the document set, exist, and various feature words, which are determined based on the document keywords, are thus output. In particular, in the case where the method (2) using deep layer learning, the method (3) using information of a community, or the like is used for searching for an associated document, even a document containing a completely different word is found in the search as an associated document. Therefore, more various words may be obtained as feature words.

Furthermore, in this exemplary embodiment, the feature word output unit 16 searches for a selected superordinate concept whose number of document keywords having a common superordinate concept is larger than the other superordinate concepts. Then, a document keyword belonging to the selected superordinate concept is output as a feature word. Therefore, various words that belong to a selected superordinate concept representing features of a document set and actually appear in a document may be output as feature words. Such a feature word is, for example, useful for a case where a user wants to perform re-search using a feature word displayed in a search result, which will be described later, as an input keyword.

Furthermore, in this exemplary embodiment, a document keyword belonging to a selected superordinate concept is output as a feature word. However, a selected superordinate concept may be output as a feature word. A selected superordinate concept represents a feature of a document set. Therefore, for example, by displaying a selected superordinate concept as a feature word in a search result, which will be described later, a user is able to confirm the summary of the document set.

As a different method for determining a feature word using the conceptual hierarchy dictionary 52, a method for searching for a superordinate concept of an input keyword and outputting a document keyword belonging to the superordinate concept as a feature word may be used. For explanation using the conceptual hierarchy dictionary in FIG. 5, in the case where an input keyword is “magnetism”, a superordinate concept of “magnetism” is “metal, and “iron, “nickel”, “aluminum”, and “brass”, which are document keywords belonging to the superordinate concept “metal”, are output as feature words. With this method, only words belonging to a superordinate concept of an input keyword may be output as feature words. Furthermore, with this method, in the case where an input keyword is a word in the first layer, which is the highest layer of the conceptual hierarchy dictionary 52 (for example, in the case of “metal” in FIG. 5), a document keyword belonging to the word (concept) may be output as a feature word.

Furthermore, in the exemplary embodiment, a single “conceptual hierarchy dictionary 52” is used. However, plural “conceptual hierarchy dictionaries 52” may be used. For example, switching between the plural “conceptual hierarchy dictionaries 52” may be performed in accordance with the attributes of a user (whether the user is a technical job, a sales job, or the like in a company). Specifically, plural “conceptual hierarchy dictionaries 52” optimized for the attributes of users are prepared in advance. For example, before starting to perform search, a user selects, using the operation unit 70, a “conceptual hierarchy dictionary 52” to be used. When the user performs search, the feature word output unit 16 outputs a feature word using the selected “conceptual hierarchy dictionary 52”. A word has many meanings, and a superordinate concept varies according to the attributes of a user who performs search. Therefore, by using the “conceptual hierarchy dictionary 52” in a selective manner, a feature word which is of more interest to each user may be output.

Furthermore, in the case where a large number of feature words are output by the process illustrated in the flowchart of FIG. 4, the number of feature words may be reduced by performing further selection. For example, the two selection methods described below are available.

The first selection method is a method for selecting a word with a high appearance frequency in a document within a document set as a target for output of a feature word and a low appearance frequency in a document within a different document set as a feature word. This is a method, for example, for selecting a feature word from among words with an appearance frequency in a document within a document set relatively higher than an appearance frequency in a document within a different document set. Such a selection method may be implemented using, for example, a tf-idf approach. In this approach, tf-idf originally indicates the weight of a word in a document, and is represented by two indices, a term frequency ((tf), an appearance frequency of a word) and an inverse document frequency (idf). In this case, by treating a collection of plural documents within a document set as a single document, the weight of a word is obtained for each document set. By preferentially selecting a word with a high tf-idf value as a feature word and not selecting a word with a low tf-idf value, the number of feature words may be reduced.

The second selection method is a method for selecting a word appearing in a large number of documents within a document set as a feature word. This is a method, for example, for more preferentially selecting a word which appears in a larger number of documents among words appearing in documents within a document set as a feature word. This selection method is implemented when a word with a high reciprocal of an idf value, that is, a high document frequency (df) value, is preferentially selected as a feature word and a word with a low df value is not selected, and thus, the number of feature words may be reduced. By combining the first selection method and the second selection method together, a feature word may be selected.

Next, display processing of S108 in FIG. 2 performed by the display processing unit 18 will be described below. The display processing unit 18 receives information of a document set from the document set generation unit 14, receives a feature word from the feature word output unit 16, and displays a search result on the display 80.

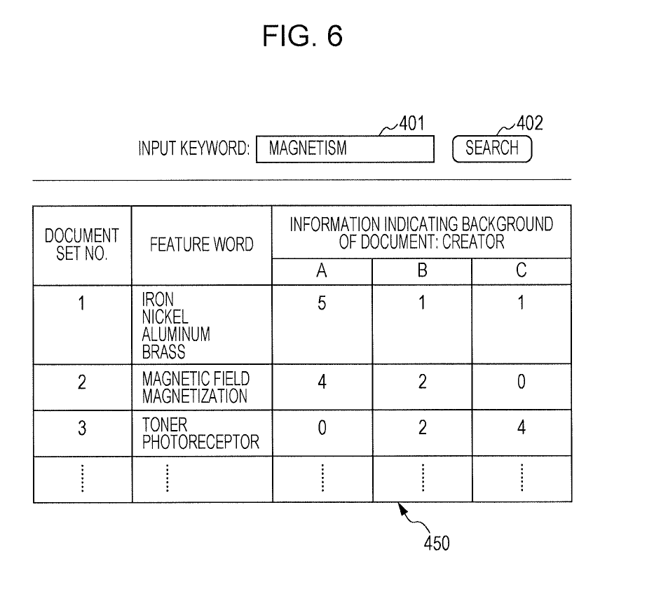

FIG. 6 illustrates a display example of a search result displayed on the display 80 in the case where search is performed when “magnetism” is input as an input keyword to a keyword input frame 401 and a search button 402 is selected and pressed by a mouse or the like of the operation unit 70. As illustrated in FIG. 6, a two-dimensional table 450 is displayed as a search result below the keyword input frame 401. In the two-dimensional table 450, display of a document set is arranged along with a feature word in one of a row and a column of a matrix, information indicating the background of a document is arranged in the other one of the row and the column of the matrix, and display regarding a document within the document set (in FIG. 6, the number of documents) is arranged as a factor of the matrix. Information indicating the background of a document is, for example, information such as a creator, a created date and time, a file format of the document, and the two-dimensional table 450 is displayed in a state in which documents contained in a document set are classified according to the information indicating the background of the document. In FIG. 6, information indicating the background of a document is “creator”, and the number of documents contained in each document set is classified according to the creator and displayed.

By displaying the above two-dimensional table 450 as a search result, compared to the case where only a feature word is displayed for each document set, features of a document within each document set may be visualized. For example, as is clear from the two-dimensional table 450, the document sets No. 1 and No. 2 each contain a large number of documents created by “A”. Therefore, it is easily understood that, for example, in the case where a user wants to search for a document created by “A”, there is a high possibility that the document created by “A” is found by checking documents contained in the document sets No. 1 and No. 2. Furthermore, by confirming feature words of individual document sets, it may be easily determined which one of the document sets No. 1 and No. 2 is associated with a document that a user wants to search for.

According to the foregoing exemplary embodiment, an associated document is contained in a document set, and therefore, various words are contained in documents within the document set. As a result, compared to a case where a basic document, which is a document containing an input keyword, is classified as a document set including similar basic documents and a feature word which is characteristic to the document set is output, more various feature words may be output.

Various feature words are displayed in a search result. Therefore, it is highly likely that a user is able to find a feature word which is regarded as being associated with a desired document from among the various feature words. By performing re-search using the feature word which is regarded as being associated with the document as an input keyword, a document which may not be obtained as a search result in an information search process using the initial input keyword may be obtained. Therefore, a desired document may be quickly reached.

As a re-search method, various methods may be available, in addition to the method using only a feature word obtained in a search result as an input keyword. For example, in the case where a first feature word, which is a feature word obtained by an information search process using a first input keyword as an input keyword, is output, refine search (AND search), extended search (OR search), peripheral search (AND-NOT search), or the like may be performed using the first input keyword and the first feature word as input keywords in the next information search process, that is, in the re-search. Next, re-search using the first input keyword and the first feature word as input keywords will be specifically explained.

In the case of refine search (AND search), in the basic document search in S100 of FIG. 2, a document containing both the first input keyword and the first feature word is searched for, and the information search process of S102 and later processing is performed. Furthermore, the method described below may also be used. First, a “basic document set of the first input keyword”, which is a document containing the first input keyword, is searched for in the basic document search in S100 of FIG. 2, an “associated document of the first input keyword”, which is an associated document associated with the “basic document of the first input keyword”, is searched for in the associated document search in S102, and a “document group of the first input keyword” including the “basic document of the first input keyword” and the “associated document of the first input keyword” is created. Similarly, basic document search and associated document search are performed for the first feature word, and a “document group of the first feature word” including the “basic document of the first feature word” and the “associated document of the first feature word” is created. Then, a document group is created by extracting a document contained in common in the “document group of the first input keyword” and the “document group of the first feature word”, and the information search process of S104 and later processing of FIG. 2 is performed for the document group.

In the case of extended search (OR search), in the basic document search in S100 of FIG. 2, a document containing the first input keyword and a document containing the first feature word are searched for, and the information search process in S102 and later processing of FIG. 2 is performed. Furthermore, as a different method, a document group including the above-mentioned “document group of the first input keyword” and “document group of the first feature word” is created, and the information search process in S104 and later processing of FIG. 2 is performed for the document group.

In the case of peripheral search (AND-NOT search), a document not containing the first input keyword is searched for from among documents containing the first feature word in the basic document search in S100 of FIG. 2, and the information search process of S102 and later processing of FIG. 2 is performed. Furthermore, as a different method, a document group containing documents contained in the “document group of the first feature word” and not contained in the “document group of the first input keyword” is created, and the information search process in S104 and later processing of FIG. 2 is performed for the document group.

As described above, by performing refine search (AND search) or peripheral search (AND-NOT search) as re-search, it is highly likely to reduce the number of documents obtained as a search result, and a user is able to easily find a desired document. Furthermore, by performing extended search (OR search) as re-search, a wide range of documents may be obtained as a search result.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for information search, the process comprising:
searching a document database for a basic document which is a document containing an input keyword;
searching the document database for an associated document associated with the basic document;
generating a plurality of document sets by classifying a document group containing a plurality of associated documents; and
outputting, for each document set, a feature word which is a word characteristic to the document set.

2. The non-transitory computer readable medium according to claim 1,
wherein a document keyword which is a keyword contained in a document within a document set is extracted, and
wherein a selected superordinate concept which is a superordinate concept whose number of document keywords having a common superordinate concept is larger than the other superordinate concepts is searched for, and all or one of the document keywords having the selected superordinate concept is defined as the feature word.

3. The non-transitory computer readable medium according to claim 2,
wherein from among the document keywords having the selected superordinate concept, all or one of document keywords with a high appearance frequency in documents within a document set as a target of output of the feature word and with a low appearance frequency in documents within the other document sets is defined as the feature word.

4. The non-transitory computer readable medium according to claim 2,
wherein from among the document keywords having the selected superordinate concept, a document keyword appearing in a large number of documents within the document set is defined as the feature word.

5. The non-transitory computer readable medium according to claim 1, the process further comprising:
displaying a two-dimensional table in which display of the document set is arranged along with the feature word in one of a row and a column of a matrix, information indicating a background of a document is arranged in the other one of the row and the column of the matrix, and display regarding a document within the document set is arranged as a factor of the matrix.

6. The non-transitory computer readable medium according to claim 1, wherein a set operation of a provisional document set generated by classifying the document group and a previously generated document set is performed to generate a document set.

7. The non-transitory computer readable medium according to claim 1, wherein in a case where a first feature word is output as the feature word when a first input keyword is used as the input keyword, at least one of re-search using the first feature word as the input keyword, refine search which is re-search using both the first input keyword and the first feature word as the input keyword, extended search, and peripheral search may be performed.

8. An information search apparatus comprising:
a basic document search unit that searches a document database for a basic document which is a document containing an input keyword;
an associated document search unit that searches the document database for an associated document associated with the basic document;
a document set generation unit that generates a plurality of document sets by classifying a document group containing a plurality of associated documents; and
a feature word output unit that outputs, for each document set, a feature word which is a word characteristic to the document set.

9. An information search method comprising:
searching a document database for a basic document which is a document containing an input keyword;
searching the document database for an associated document associated with the basic document;
generating a plurality of document sets by classifying a document group containing a plurality of associated documents; and
outputting, for each document set, a feature word which is a word characteristic to the document set.
